(19) United States
(12) Patent Application Publication
(10) Pub. No.: US 2017/0129311 A1
(43) Pub. Date: May 11, 2017

(54) AIR CONDITIONING SYSTEM AND METHOD OF CONTROLLING THE SAME

(71) Applicant: FORD GLOBAL TECHNOLOGIES, LLC, Dearborn, MI (US)

(72) Inventor: Harold LI, Nanjing (CN)

(73) Assignee: FORD GLOBAL TECHNOLOGIES, LLC, Dearborn, MI (US)

(21) Appl. No.: 15/298,110

(22) Filed: Oct. 19, 2016

(30) Foreign Application Priority Data
Nov. 6, 2015 (CN) 2015 10 752 178.6

(51) Int. Cl. B60H 1/32

(52) U.S. Cl. CPC B60H 1/3205; B60H 2001/3254; B60H 2001/3261; B60H 2001/3255; B60H 2001/3272; B60H 2001/3285; B60H 2001/3277

(57) ABSTRACT

The present disclosure provides a method of controlling an air conditioning system of a vehicle. The method includes controlling a compressor to adjust a flow of refrigerant discharged from the compressor to obtain a target refrigerant pressure responsive to an actual refrigerant pressure upstream an inlet of an electric expansion valve. The method also includes controlling the valve to adjust the flow entering an evaporator to obtain a target evaporator surface temperature responsive to an actual evaporator temperature.

### CROSS-REFERENCE TO RELATED APPLICATION

This application claims foreign priority benefits under 35 U.S.C. §119(a)-(d) to CN 2015 10 752 178.6 filed Nov. 6, 2015, which is hereby incorporated by reference in its entirety.

### TECHNICAL FIELD

The present disclosure relates to an air conditioning system and a method of controlling the same.

### BACKGROUND

Vehicles may be equipped with air conditioning systems to provide comfort for passengers. The air conditioning system may include a compressor, a condenser, an evaporator, and an expansion device. The compressor compresses a refrigerant to increase the refrigerant pressure, and then transfers the compressed and pressurized refrigerant though the condenser to cause the refrigerant to cool down. The refrigerant fluid expands in the expansion device and thus the refrigerant pressure is reduced. Low pressure fluid then evaporates in the evaporator and absorbs heat. Accordingly, the air flow passing through the evaporator is cooled and sent to vehicle cabin.

The evaporator surface temperature may be kept constant by adjusting the displacement of the compressor, and a variable related to a superheat of the evaporator may be adjusted by controlling the electric expansion valve in response to a control signal.

### SUMMARY

According to one aspect of the present disclosure, a method is provided to control an air conditioning system of a vehicle. The method includes controlling a compressor to adjust a flow of refrigerant discharged from the compressor to obtain a target refrigerant pressure responsive to an actual refrigerant pressure upstream an inlet of an electric expansion valve. The method also includes controlling the valve to adjust the flow entering an evaporator to obtain a target evaporator surface temperature responsive to an actual evaporator temperature.

In one embodiment, the target refrigerant pressure and the target evaporator surface temperature are based on inputs including environmental parameters, a cabin temperature of the vehicle, or an air conditioner input by a user, and the environmental parameters include an ambient temperature or a sun load.

In another embodiment, the target refrigerant pressure and the target evaporator surface temperature are further based on an actual duct air flow temperature.

In another embodiment, the target refrigerant pressure and the target evaporator surface temperature are determined by a look-up table stored in an air conditioner controller, and the look-up table includes the environmental parameters, the air conditioner input, and the corresponding target refrigerant pressure and target evaporator surface temperature.

In another embodiment, the method also includes modifying the target refrigerant pressure and the target evaporator surface temperature based on a required duct air flow temperature and an actual duct air flow temperature, wherein the required duct air flow temperature is based on the inputs. The method also includes controlling the compressor to obtain a modified target refrigerant pressure in response to the actual refrigerant pressure. The method also includes controlling the electric expansion valve to obtain the modified target evaporator surface temperature in response to the actual evaporator temperature.

In another embodiment, the actual refrigerant pressure is detected by a pressure sensor located adjacent to the inlet of the electric expansion valve in a refrigerant line.

In another embodiment, the actual evaporator temperature is detected by a temperature sensor located at a core of the evaporator.

In another embodiment, the actual evaporator temperature is detected by a temperature sensor located adjacent to an outlet of the evaporator.

In another embodiment, the method also includes controlling a speed of a cooling fan disposed adjacent to a condenser and a speed of the compressor to obtain the target refrigerant pressure in response to the actual refrigerant pressure.

In another embodiment, the compressor is controlled by a power control module to discharge the flow of refrigerant required to obtain the target refrigerant pressure, and the power control module electrically connects to an air conditioner controller and a pressure sensor detecting the actual refrigerant pressure.

In another embodiment, the electric expansion valve is controlled by an electric expansion valve controller to adjust the flow of refrigerant entering into the evaporator to obtain the target evaporator surface temperature, and the electric expansion valve controller electrically connects to the air conditioner controller and a temperature sensor detecting the actual evaporator temperature.

According to another aspect of the present disclosure, a method of controlling an air conditioning system of a vehicle is provided. The method includes controlling a compressor to obtain a target refrigerant pressure responsive to an actual refrigerant pressure. The method also includes controlling an electric expansion valve to obtain a target evaporator surface temperature responsive to an actual evaporator temperature. The target pressure and target temperature are based on an actual duct air flow temperature and a required duct air flow temperature that is based on inputs.

In one embodiment, controlling the compressor includes adjusting an amount of power delivered to the compressor by using a power control module to discharge a flow of refrigerant, and wherein the power control module electrically connects to a pressure sensor detecting actual refrigerant pressure at a refrigerant line adjacent to an inlet of the electric expansion valve.

In another embodiment, controlling the electric expansion valve includes adjusting a flow of refrigerant entering into an evaporator.

In another embodiment, the method also includes controlling an amount of power delivered to the compressor to discharge a refrigerant flow required to obtain a target refrigerant temperature in response to an actual temperature detected at a refrigerant line before an inlet of the electric expansion valve.

According to another aspect of the present disclosure, an air conditioning system is provided. The air conditioning system comprises a compressor, an evaporator, an electric expansion valve connected upstream of the evaporator, and a controller. The controller is configured to control the valve to obtain a target evaporator surface temperature responsive to a detected evaporator temperature and to adjust the compressor to obtain a target refrigerant pressure responsive to a detected refrigerant pressure upstream of the valve. The target temperature and target pressure are based on environmental parameters.

In one embodiment, a temperature sensor detecting the detected evaporator temperature is positioned on a core of the evaporator.

In another embodiment, the temperature sensor is positioned adjacent to an outlet of the evaporator.

In another embodiment, a pressure sensor detecting the detected refrigerant pressure is positioned on a refrigerant line adjacent an inlet of the electric expansion valve.

In another embodiment, the air conditioning system also includes a condenser and a cooling fan positioned adjacent to the condenser.

In another embodiment, the controller is further configured to adjust a speed of the cooling fan and of the compressor to obtain the target refrigerant pressure in response to the detected refrigerant pressure.

One or more advantageous features as described herein are believed to be readily apparent from the following detailed description of one or more embodiments when taken in connection with the accompanying drawings.

### BRIEF DESCRIPTION OF THE DRAWINGS

FIG. 1 depicts a schematic view of an air conditioning system of a vehicle according to one or more embodiments of the present disclosure.

FIG. 2 depicts a functional block diagram for controlling the air conditioning system referenced in FIG. 1 according to one or more embodiments of the present disclosure.

FIG. 3 is a flowchart illustrating a method to control an air conditioning system according to one or more embodiments of the present disclosure.

FIG. 4 is a flowchart illustrating a method to control the air conditioning system according to one or more embodiments of the present disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

As referenced in the figures, the same reference numerals may be used herein to refer to the same parameters and components or their similar modifications and alternatives. These parameters and components are included as examples and are not meant to be limiting. The drawings referenced herein are schematic and associated views thereof are not necessarily drawn to scale.

A control strategy may maintain a constant evaporator surface temperature via adjusting the displacement of a compressor. In order to achieve input temperature by a user, the compressor may be run in over-capacity state. Under some circumstances, the evaporator surface temperature may be lower than zero, and thus the displacement of the compressor may be reduced or suspended to avoid icing on the evaporator. In addition, it takes time for the air conditioning system to adjust the evaporator surface temperature to a desired temperature when the compressor operates in response to a control signal. Further, a larger relative temperature fluctuation of air flow entering the cabin may reduce the user's satisfaction. Furthermore, some control strategies of an air conditioning system may employ a mixing box to achieve a required temperature, which may bring turbulent air flow and noise issues. The present disclosure may address at least some of the above issues.

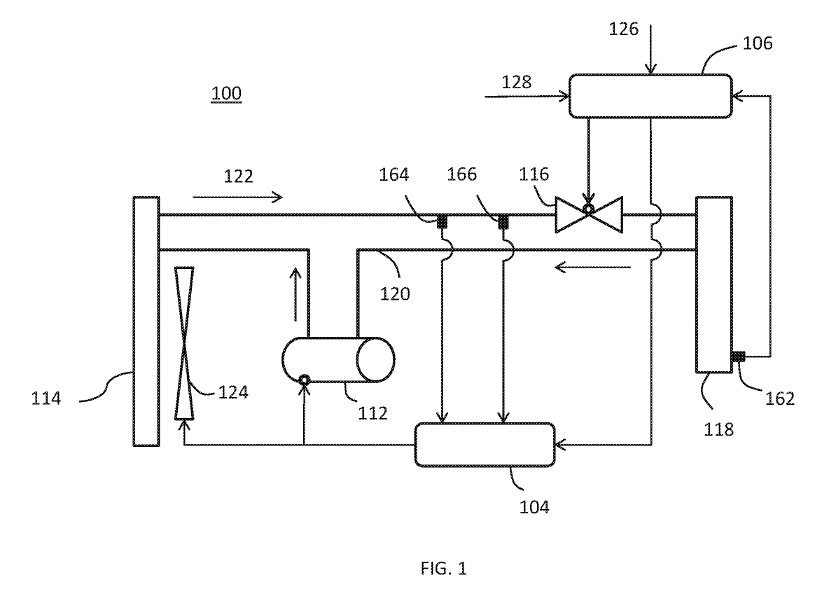

FIG. 1 depicts a schematic view of an air conditioning system 100 in a vehicle. In one or more embodiments, the air conditioning system 100 may include a compressor 112, a condenser 114, an expansion valve 116, an evaporator 118, and a refrigerant line 120 sequentially connected there-between. The refrigerant line 120, the compressor 112, the condenser 114, the expansion valve 116, and the evaporator 118 together form an air conditioning loop 122.

The compressor 112 receives and compresses refrigerant fluid in a gaseous state to increase a pressure of the refrigerant fluid, and in one embodiment the compressor 112 may be an externally controlled variable displacement compressor (ECVDC), which may vary its pumping capacity or the displacement in response to an external control signal. Then, the high pressure refrigerant fluid passes through the condenser 114, and is cooled into liquid.

In one or more embodiments, the air conditioning system 100 may further include a cooling fan 124 disposed adjacent to the condenser 114 to further strengthen/enhance the cooling effect.

In one or more embodiments, the expansion valve 116 may be an electric expansion valve, which may be located downstream of the condenser 114 and upstream of the evaporator 118 for controlling a flow of refrigerant entering into evaporator 118. The electric expansion valve 116 limits the flow of the refrigerant entering into the evaporator 118 causing the pressure of the refrigerant liquid to decrease. The low pressure refrigerant liquid evaporates into gas, absorbs heat, and exchanges heat with the air passing the evaporator 118, thus the air to be sent to the cabin is cooled.

The air conditioning system 100 further includes a temperature sensor 162 to detect a temperature of the evaporator 118. The temperature detected by the temperature sensor 162 corresponds to the evaporator surface temperature. In one or more embodiments, the temperature sensor 162 may be located at a core of the evaporator 118. In other embodiments, the temperature sensor 162 may be disposed adjacent to an outlet of the evaporator 118.

The air conditioning system 100 may include a pressure sensor 164 to detect a refrigerant pressure upstream of the electric expansion valve 116. The pressure sensor 164 may be located in the refrigerant line 120 adjacent to an inlet of the electric expansion valve 116. In one embodiment, the air conditioning system 100 may further include a temperature sensor 166 to detect the refrigerant temperature upstream of the electric expansion valve 116. The temperature sensor 166 may be located in the refrigerant line 120 adjacent to the inlet of the electric expansion valve 116.

The air conditioning system 100 may include one or more controller, which may be integrated as a single controller or control module as need. As depicted in FIG. 1, one or more controllers of the air conditioning system 100 may include a power control module (PCM) 104, air conditioner controller (also referred as climate control head) 106, and an electric expansion valve controller (not shown) etc. In an alternative embodiment, the electric expansion valve controller may also be integrated into the air conditioner controller 106. The air conditioner controller 106 may be electrically connected to the temperature sensor 162 to receive a detected temperature of the evaporator 118. Further, the air conditioner controller 106 may also receive an environmental input 126 and a user input 128 (for instance, an air conditioner input). The power control module 104 may be electrically connected to the air conditioner controller 106, to the pressure sensor 164 that detects a refrigerant pressure at the refrigerant line 120 adjacent to the inlet of the electric expansion valve 116, and to the temperature sensor 166 that detects a refrigerant temperature upstream of the electric expansion valve 116.

In one or more embodiments, the electric expansion valve controller may be configured to adjust the electric expansion valve 116 to obtain the target evaporator surface temperature in response to the detected temperature of the evaporator 118, and the power control module 104 may be configured to adjust the compressor 112 to obtain the target refrigerant pressure in response to the detected pressure upstream of the electric expansion valve 116. The target evaporator temperature and target refrigerant pressure may be determined based on environmental parameters. The power control module 104 may be further configured to adjust a speed of the fan 124 to obtain the target refrigerant pressure in response to the detected pressure.

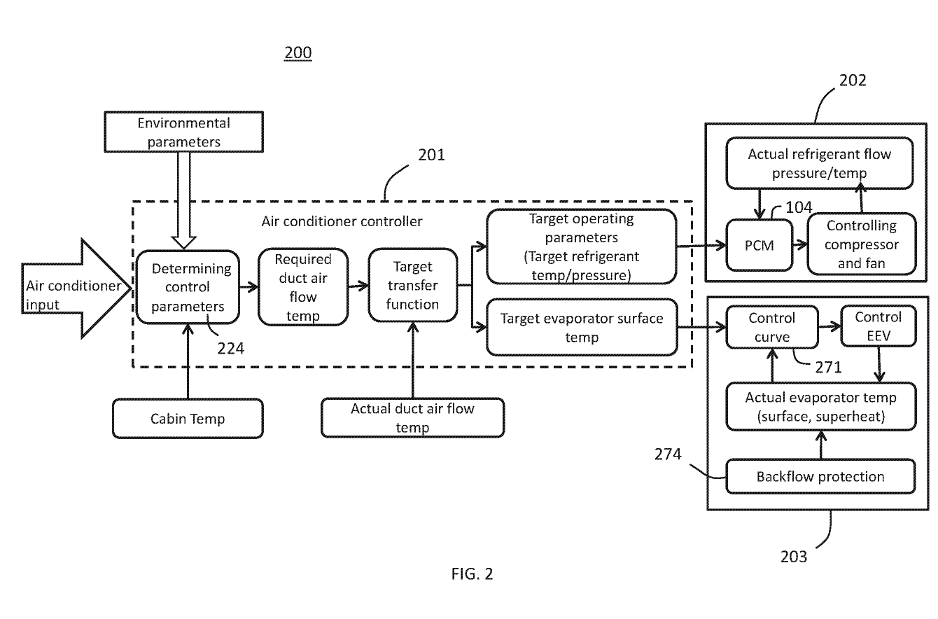

FIG. 2 depicts a functional block diagram 200 of the air conditioning system 100 referenced in FIG. 1. The functional block diagram 200 may be divided into three parts, an air conditioner controller part 201, a compressor control part 202 and an evaporator/electric expansion valve control part 203. As depicted, the air conditioner controller part 201 receives input parameters, determines operating parameters and outputs control signals. The air conditioner controller 106 may determine control or operating parameters at 224. In one or more embodiments, the air conditioner controller 106 may include an analysis module, which may receive input parameters, for instance, environmental parameters, the air conditioner input by a user and/or cabin temperature at 224. The environmental parameters may include ambient temperature and sun load. The analysis module may determine a cooling load based on input parameters.

In one or more embodiments, cooling load (A_{CoolingLoad}) may be calculated from the following formula:

A_{CoolingLoad}=μ(T_{Setting}−T_{Cabin})+αT_{Ambient}+βS_{Sunload}+σ

wherein T_{setting} is an air conditioner input by a user, T_{Cabin} is cabin temperature, T_{Ambient} is surrounding environment temperature, S_{Sunload} is sun load. μ, α, β are gains, and σ is a compensation coefficient.

The analysis module may further determine the duct air flow temperature required to obtain the cooling load. In one embodiment, the analysis module may utilize a control parameter matrix to calculate the duct air flow temperature required to obtain the cooling load.

The required duct air flow temperature may be broken down into one or more target operating parameters via a target transfer function. As depicted in FIG. 2, in one or more embodiments, the target operating parameters may include the target refrigerant pressure before entering into the evaporator and the target evaporator surface temperature. In another embodiment, the target operating parameters may include a target evaporator refrigerant pressure. The corresponding actual pressure may be detected by a pressure sensor disposed within the evaporator or disposed at inlet or outlet of the evaporator.

As depicted in FIG. 2, in one embodiment, the target operating parameters may be determined based on the required duct air flow temperature and the actual duct air flow temperature via a target transfer function. In one or more embodiments, the target operating parameters may be determined from a look-up table stored in the analysis module of the air conditioner controller 106. The look-up table includes relevant variables, for instance environmental parameters, air conditioner settings and corresponding target operating parameters (for instance a target refrigerant pressure/temperature and a target evaporator surface temperature/target evaporator refrigerant temperature). It is understood that any suitable method may be used to determine the target operating parameters. The air conditioner controller part 201 outputs the target operating parameters to the compressor control part 202 and the evaporator/electric expansion valve control part 203.

The compressor control part 202 controls the displacement of the compressor based on the target operating parameters related to the compressor. The compressor control part 202 may include a power control module 104. In one embodiment, the compressor control part 202 is a single control unit. In other embodiments, the compressor control part 202 may be integrated into the air conditioner controller part 201. The power control module 104 adjusts the refrigerant displacement of the compressor to obtain the compressor target operating parameters. In one or more embodiments, the compressor control part 202 uses a feedback control to obtain the target operating parameters. For instance, in response to a refrigerant pressure detected in the refrigerant line before the inlet of the electric expansion valve 116, the power control module 104 controls the compressor 112 to obtain the target refrigerant pressure. In one or more embodiments, the power control module 104 may increase or reduce a current to compressor to control the displacement of the compressor.

Further, the power control module 104 may control a cooling fan 124 adjacent to the condenser 114 (referring to FIG. 1). The power control module 104 may control the speed of the fan 124 based on the detected refrigerant pressure. In one embodiment, the power control module 104 concurrently implements a feedback control to the compressor and cooling fan to obtain the target refrigerant pressure.

The evaporator/electric expansion valve control part 203 may adjust/control the refrigerant flow entering into the evaporator via an electric expansion valve controller to obtain the target evaporator surface temperature. In one or more embodiments, the electric expansion valve controller may include a control curve 271. For instance, the electric expansion valve controller may include a control function or control curve for controlling a step motor of the electric expansion valve. The control function is associated with the target evaporator parameters and the detected evaporator parameters. The detected evaporator parameters may be an evaporator surface temperature, a refrigerant pressure in the evaporator or the refrigerant pressure at inlet or outlet of the evaporator. In one embodiment, the control function may be related to the target evaporator surface temperature and the detected evaporator temperature. The electric expansion valve controller may determine a step position of the step motor based on the control function. The step motor is operated to the corresponding position to adjust the valve based on an instruction, which may quickly and precisely control the refrigerant flow entering into the electric expansion valve. In one or more embodiments, the temperature control curve may be determined based on a target evaporator surface temperature. The electric expansion valve controller may control the evaporator surface temperature and superheat based on a temperature control curve to fit the actual evaporator surface temperature to the temperature control curve at 271. In one or more embodiments, the electric expansion valve may be controlled via implementing closed loop control by a Proportional-Integral-Derivative controller (PID).

In this way, the target evaporator surface temperature may be quickly reached by direct control of the electric expansion valve in response to the actual evaporator temperature. Further, the core of the evaporator may work under lower operating temperatures (approximate to zero degree Celsius, for instance, including but not limited to around two degree Celsius). Thus, the delay and overshooting caused by indirect control of the compressor 112 may be avoided.

In addition, at 274, the evaporator/electric expansion valve control part may also include a backflow protection of the compressor. In one or more embodiments, a liquid reservoir may be used to achieve the backflow protection of the compressor.

The embodiments of the present disclosure are advantageous in that the evaporator surface temperature may be adjusted in a wide range, including but not limited to temperatures in a range from two to twenty degrees Celsius, so that there may be no need to employ a mixing box to reheat the air flow passing the evaporator under most circumstances, thus reducing air flow turbulence and noise.

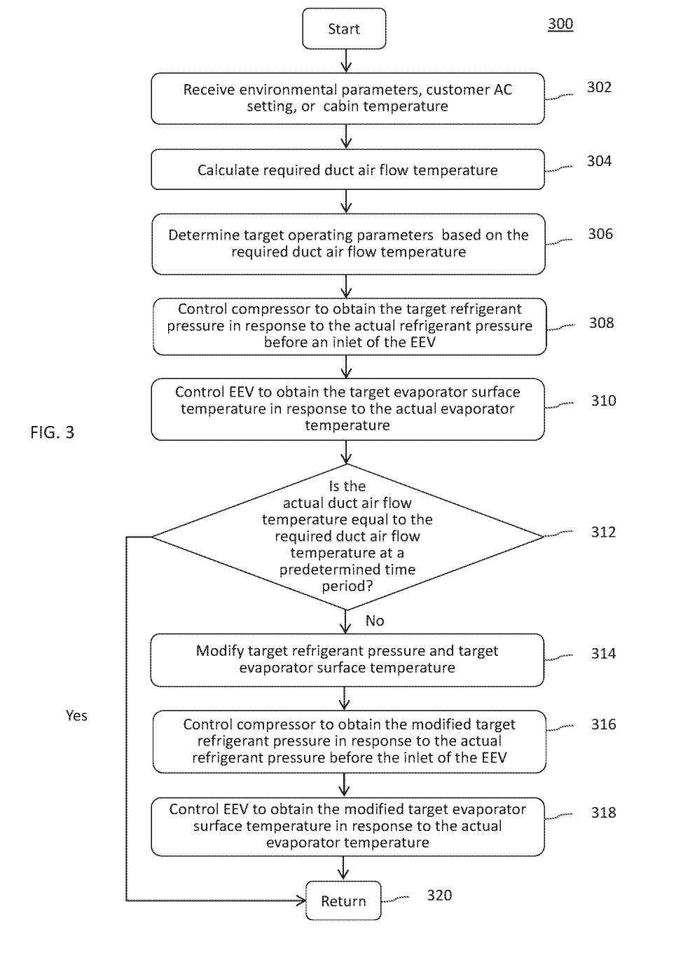

FIG. 3 shows a flowchart of a method to control an air conditioning system 100 according to one or more embodiments of the present disclosure. At 302, method 300 receives environmental parameters, air conditioner input by a user and/or cabin temperature. The environmental parameters may include ambient temperature or sun load. Ambient temperature and sun load may be detected by a temperature sensor and a sun load sensor, respectively.

At 304, the duct air flow temperature required to obtain the cooling load is calculated based on the environmental parameters and the air conditioner input by a user. The cooling load may be calculated according to the approach referenced in FIG. 2. It is understood that the cooling load may be calculated based on other suitable methods. The required duct air flow temperature may also be calculated based on other suitable methods.

Next, method 300 proceeds to 306, and may determine the target operating parameters. At 306, in one or more embodiments, the target operating parameters may be determined based on the required duct air flow temperature. In one embodiment, the target operating parameter for controlling the compressor may be a target refrigerant pressure before entering into the evaporator. In other embodiments, the target operating parameters for controlling the compressor may be a target refrigerant temperature before entering into the evaporator. In another embodiment, the target operating parameters for controlling the compressor may be the target refrigerant pressure and temperature before entering into the evaporator. In one or more embodiments, the target operating parameters for controlling the evaporator may be the target evaporator surface temperature. It is understood that any suitable methods may be used to determine the target operating parameters. For instance, the target operating parameters may be determined from the environmental parameters and air conditioner input by a user. In addition, as depicted in FIG. 3, the target operating parameters, for instance the target refrigerant pressure and the target evaporator surface temperature, may be determined further based on an actual duct air flow temperature. In one or more embodiments, the target refrigerant pressure and the target evaporator surface temperature may be determined based on a look-up table stored in an air conditioner controller, wherein the look-up table includes environmental parameters, air conditioner input and a corresponding target refrigerant pressure and the target evaporator surface temperature. The look-up table may further include but not limited to a cabin temperature, a target refrigerant temperature, and/or a target evaporator refrigerant temperature.

Next, the method 300 proceeds to 308, and controls the compressor 112 to obtain the target refrigerant pressure in response to the actual refrigerant pressure at the refrigerant line before the inlet of the electric expansion valve (EEV) 116. According to one or more embodiments of the present disclosure, the actual refrigerant pressure may be detected by a pressure sensor 164 located at the refrigerant line 120 adjacent to the inlet of the electric expansion valve 116. The compressor 112 may be controlled to discharge the refrigerant flow required to obtain the target refrigerant pressure via adjustment of an amount of power delivered to the compressor 112 by a power control module 104. The power control module 104 is electrically connected to the air conditioner controller 106 and the pressure sensor 164 that detects a refrigerant pressure.

In one or more embodiments, controlling the compressor may further include controlling the compressor 112 to discharge the refrigerant flow required to obtain the target refrigerant temperature in response to the actual refrigerant temperature detected at the refrigerant line 120 before the inlet of the electric expansion valve 116. The power control module 104 is electrically connected to the air conditioner controller 106 and the temperature sensor 166 that detects the refrigerant temperature at the refrigerant line 120 adjacent to the inlet of the electric expansion valve 116.

In addition, the air conditioning system 100 may further include a cooling fan 124 located adjacent to the condenser 114. The method 300 further includes controlling the speed of the cooling fan 124 and compressor 112 via the power control module 104 to obtain the target refrigerant pressure and/or the target refrigerant temperature based on the detected actual refrigerant pressure and/or the actual refrigerant temperature.

Next, the method 300 proceeds to 310, and controls the electric expansion valve 116 to obtain the target evaporator surface temperature in response to the actual evaporator temperature. The actual evaporator temperature may be detected by a temperature sensor 162 located at the core of the evaporator 118. It is understood that the actual evaporator surface temperature may also be detected by a temperature sensor located adjacent to the outlet of the evaporator 118. The temperature sensor may be located at a suitable location to measure a temperature substantially representing or approximating the evaporator surface temperature.

The electric expansion valve 116 is controlled by the electric expansion controller to adjust the refrigerant flow entering into the evaporator 118 to obtain the target evaporator surface temperature. The electric expansion valve controller is electrically connected to the air conditioner controller 106 and the temperature sensor 162 that detects the evaporator temperature.

At 312, the method 300 determines if the actual duct air flow temperature is substantially equal to the required duct air flow temperature within a predetermined time. If the answer is yes, then the method 300 proceeds to 320 and returns. If the answer is no, then the method 300 proceeds to 314. At 314, the target operating parameters, for instance, the target refrigerant pressure and the target evaporator surface temperature, may be modified based on the required duct air flow temperature and the actual duct air flow temperature. Next, at 316, the method 300 controls the compressor 112 to obtain a modified target refrigerant pressure in response to the actual refrigerant pressure at the refrigerant line 120 before the inlet of the electric expansion valve 116. At 318, the method 300 controls the electric expansion valve 116 to obtain a modified target evaporator surface temperature in response to the actual evaporator temperature. The method 300 then proceeds to 320 and returns.

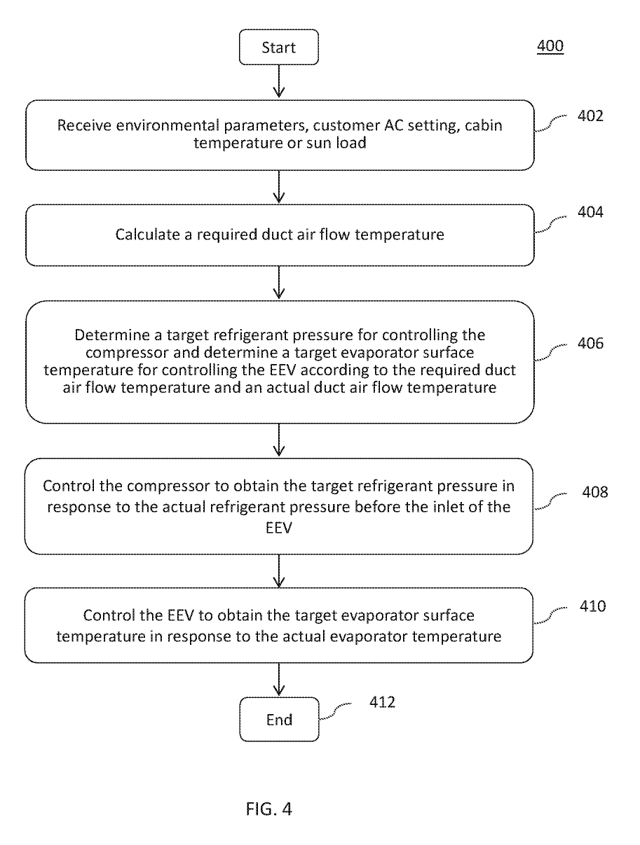

Referring to FIG. 4, which depicts a control method flowchart 400 of an air conditioning system according to one embodiment of the present disclosure. The method 400 begins at 402, and receives environmental parameters, customer AC setting (e.g., air conditioner input by a user) and/or cabin temperature. The environmental parameters may include but not limited to ambient temperature or sun load.

At 404, the method 400 includes calculating the duct air flow temperature required to obtain the cooling load (A_{CoolingLoad}) based on the environmental parameters and air conditioner input by the user which are received at 402. The required duct air flow temperature may also be calculated based on other suitable methods.

Next, the method 400 proceeds to 406 and the method 400 may include determining the target operating parameters based on the required duct air flow temperature and the actual duct air flow temperature. In one or more embodiments, the target refrigerant pressure for controlling the compressor 112 is determined based on the required duct air flow temperature and the actual duct air flow temperature, and the target evaporator surface temperature for controlling the electric expansion valve (EEV) 116 is determined based on the required duct air flow temperature and the actual duct air flow temperature.

In one or more embodiments, the method 400 may also include determining the target refrigerant temperature for controlling the compressor 112 based on the required duct air flow temperature and the actual duct air flow temperature.

Next, at 408 the method 400 may include controlling the compressor 112 to obtain the target refrigerant pressure in response to the actual refrigerant pressure detected at the refrigerant line 120 before the inlet of the electric expansion valve (EEV) 116. Controlling the compressor 112 may include adjusting the power delivered to the compressor 112 by a power control module 104 to discharge a refrigerant flow required to obtain the target refrigerant pressure. The power control module 104 is electrically connected to an air conditioner controller 106 and a pressure sensor 164 that detects the refrigerant pressure at the refrigerant line 120 adjacent to the inlet of the electric expansion valve 116. In one or more embodiments, controlling the compressor 112 may further include controlling the compressor 112 to discharge the refrigerant flow required to obtain the target refrigerant temperature in response to the actual refrigerant temperature detected at the refrigerant line 120 before the inlet of the electric expansion valve 116. The power control module 104 is electrically connected to an air conditioner controller 106 and a temperature sensor 166 that detects the refrigerant temperature at the refrigerant line 120 adjacent to the inlet of the electric expansion valve 116.

At 410, the method 400 may include controlling the electric expansion valve 116 to obtain the target evaporator surface temperature in response to the actual evaporator temperature detected at the evaporator 118. The electric expansion valve 116 is controlled by the electric expansion controller to adjust the refrigerant flow entering into the evaporator 118. The electric expansion valve 116 is electrically connected to the air conditioner controller 106 and the temperature sensor 162 that detects the evaporator surface temperature. In addition, the air conditioning system 100 may further include a cooling fan 124 located adjacent to the condenser 114. The method 400 may further include controlling a speed of the cooling fan 124 and compressor 112 via the power control module 104 to obtain the target refrigerant pressure based on the detected refrigerant pressure and/or the detected refrigerant temperature. Next, the method 400 proceeds to 412 and returns.

The air conditioner control system may be broken into subsystems. The interaction between the subsystems may be advantageous to achieve quick and effective system control. In addition, in one or more embodiments, the control method controls different operating parameters, for instance adjusting the compressor based on pressure and adjusting the electric expansion valve based on temperature. Therefore, the control system and method of the present disclosure may rapidly respond to a change of an operating condition so as to achieve an improved cooling effect. For achieving the same cooling effect, the air conditioning system may be more compact. The use of the electric expansion valve in the air conditioning system may further reduce the response time of the air conditioning system, thus allowing the evaporator to work at a lower temperature, for instance approximating to zero degree Celsius.

In one or more embodiments, the present disclosure as set forth herein is believed to have overcome certain challenges associated with the air conditioning system. However, one skilled in the art will readily recognize from such discussion, and from the accompanying drawings and claims that various changes, modifications and variations can be made therein without departing from the true spirit and fair scope of the disclosure.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method of controlling an air conditioning system in a vehicle, comprising:
controlling a compressor to adjust a flow of refrigerant discharged from the compressor to obtain a target refrigerant pressure responsive to an actual refrigerant pressure upstream an inlet of an electric expansion valve; and
controlling the valve to adjust the flow entering an evaporator to obtain a target evaporator surface temperature responsive to an actual evaporator temperature.

2. The method of the claim 1, wherein the target refrigerant pressure and the target evaporator surface temperature are based on inputs including environmental parameters, a cabin temperature of the vehicle, or an air conditioner input by a user, and wherein the environmental parameters include an ambient temperature or a sun load.

3. The method of the claim 2, wherein the target refrigerant pressure and the target evaporator surface temperature are further based on an actual duct air flow temperature.

4. The method of the claim 2, wherein the target refrigerant pressure and the target evaporator surface temperature are determined by a look-up table stored in an air conditioner controller, and wherein the look-up table includes the environmental parameters, the air conditioner input, and the corresponding target refrigerant pressure and target evaporator surface temperature.

5. The method of claim 2, further comprising:
modifying the target refrigerant pressure and the target evaporator surface temperature based on a required duct air flow temperature and an actual duct air flow temperature, wherein the required duct air flow temperature is based on the inputs;
controlling the compressor to obtain a modified target refrigerant pressure in response to the actual refrigerant pressure; and
controlling the electric expansion valve to obtain the modified target evaporator surface temperature in response to the actual evaporator temperature.

6. The method of the claim 1, wherein the actual refrigerant pressure is detected by a pressure sensor located adjacent to the inlet of the electric expansion valve in a refrigerant line.

7. The method of the claim 1, wherein the actual evaporator temperature is detected by a temperature sensor located at a core of the evaporator.

8. The method of the claim 1, wherein the actual evaporator temperature is detected by a temperature sensor located adjacent to an outlet of the evaporator.

9. The method of the claim 1, further comprising controlling a speed of a cooling fan disposed adjacent to a condenser and a speed of the compressor to obtain the target refrigerant pressure in response to the actual refrigerant pressure.

10. The method of the claim 1, wherein the compressor is controlled by a power control module to discharge the flow of refrigerant required to obtain the target refrigerant pressure, and wherein the power control module electrically connects to an air conditioner controller and a pressure sensor detecting the actual refrigerant pressure.

11. The method of the claim 10, wherein the electric expansion valve is controlled by an electric expansion valve controller to adjust the flow of refrigerant entering into the evaporator to obtain the target evaporator surface temperature, and wherein the electric expansion valve controller electrically connects to the air conditioner controller and a temperature sensor detecting the actual evaporator temperature.

12. A method of controlling an air conditioning system in a vehicle, comprising:
controlling a compressor to obtain a target refrigerant pressure responsive to an actual refrigerant pressure; and
controlling an electric expansion valve to obtain a target evaporator surface temperature responsive to an actual evaporator temperature,
wherein the target pressure and target temperature are based on an actual duct air flow temperature and a required duct air flow temperature that is based on inputs.

13. The method of the claim 12, wherein controlling the compressor includes adjusting an amount of power delivered to the compressor by using a power control module to discharge a flow of refrigerant, and wherein the power control module electrically connects to a pressure sensor detecting actual refrigerant pressure at a refrigerant line adjacent to an inlet of the electric expansion valve.

14. The method of the claim 12, wherein controlling the electric expansion valve includes adjusting a flow of refrigerant entering into an evaporator.

15. The method of the claim 12, further comprising controlling an amount of power delivered to the compressor to discharge a refrigerant flow required to obtain a target refrigerant temperature in response to an actual temperature detected at a refrigerant line before an inlet of the electric expansion valve.

16. An air conditioning system, comprising:
a compressor;
an evaporator;
an electric expansion valve connected upstream of the evaporator; and
a controller configured to control the valve to obtain a target evaporator surface temperature responsive to a detected evaporator temperature and to adjust the compressor to obtain a target refrigerant pressure responsive to a detected refrigerant pressure upstream of the valve,
wherein the target temperature and target pressure are based on environmental parameters.

17. The air conditioning system of the claim 16, wherein a temperature sensor detecting the detected evaporator temperature is positioned on a core of the evaporator.

18. The air conditioning system of the claim 16, wherein a pressure sensor detecting the detected refrigerant pressure is positioned on a refrigerant line adjacent an inlet of the electric expansion valve.

19. The air conditioning system of the claim 16, further comprising a condenser and a cooling fan positioned adjacent to the condenser.

20. The air conditioning system of the claim 19, wherein the controller is further configured to adjust a speed of the cooling fan and of the compressor to obtain the target refrigerant pressure in response to the detected refrigerant pressure.
